(19) United States
(12) Patent Application Publication
(10) Pub. No.: US 2026/0360072 A1
(43) Pub. Date: Nov. 12, 2026

(54) AUTOMATIC CAMERA PLACEMENT FOR 3D SCENE CAPTURE

(71) Applicant: Unity Technologies SF, San Francisco, CA (US)

(72) Inventors: Alexander Suvorov, Berlin (DE); Ralph Leonard Hauwert, Charlottenlund (DK)

(21) Appl. No.: 19/200,484

(22) Filed: May 6, 2025

(51) Int. Cl. G06T 15/20; G06T 15/00

(52) U.S. Cl. CPC G06T 15/20; G06T 15/005; G06T 2210/36

(57) ABSTRACT

A method of automatic camera placement is disclosed. A signed distance field (SDF) or unsigned distance field (UDF) is computed for a three-dimensional object in a scene. Initial positions for a plurality of sampling cameras are generated. The initial positions may be generated according to an attractor function that is based on the SDF or UDF and defines where the plurality of sampling cameras should be placed relative to the three-dimensional object. Repulsion forces between pairs of the plurality of sampling cameras are defined to distribute the plurality of sampling cameras in space. The repulsion forces can be modulated by a repulsion modulator function to increase camera density in areas of higher importance. The initial positions for the plurality of sampling cameras are optimized by minimizing a loss function that balances the repulsion forces between cameras and values of the attractor function at camera positions.

### TECHNICAL FIELD

The present disclosure generally relates to automatic camera placement for three-dimensional (3D) scene reconstruction, and, in one specific embodiment, to optimizing sampling camera positions for high-quality synthetic scene visualization on low-end devices.

### BACKGROUND

Three-dimensional (3D) scene reconstruction and visualization have traditionally faced significant challenges in balancing computational requirements with visual quality. Conventional approaches to scene visualization often require substantial computational resources, making high-fidelity rendering difficult on resource-constrained devices. Current methods for camera placement in scene reconstruction typically rely on manual positioning or simplistic automated approaches that do not account for the varying complexity of different regions within a scene. Additionally, existing techniques for optimizing rendering quality frequently involve trade-offs between processing power and visual fidelity, with limited ability to intelligently allocate computational resources based on the importance of different scene elements. These limitations have particularly impacted applications in product visualization, industrial use cases, and interactive experiences on low-end devices, where the ability to render complex scenes with high visual quality remains a significant technical challenge.

### BRIEF DESCRIPTION OF THE DRAWINGS

Features and advantages of the present invention will become apparent from the following detailed description, taken in combination with the appended drawings, in which:

FIG. 1 is a block diagram illustrating example modules of the system;

FIG. 2 is a flowchart depicting an example method for automatic camera placement for 3D scene capture;

FIG. 3 is a flowchart depicting an example method of computing the repulsion modulator function described with respect to FIG. 2;

FIG. 4 is a flowchart depicting an example method of computing an adaptive repulsion modulator function;

FIG. 5 is a flowchart depicting an example method of computing adaptive camera count control;

FIG. 6 is a block diagram illustrating an example software architecture, which may be used in conjunction with various hardware architectures herein described; and

FIG. 7 is a block diagram illustrating example components of a machine that is configured to read instructions (e.g., from a machine-readable storage medium) and perform any one or more of the operations or methodologies discussed herein.

### DETAILED DESCRIPTION

The description that follows describes systems, methods, techniques, instruction sequences, and computing machine program products that constitute illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details.

In example embodiments, the described system implements one or more techniques for automatic camera placement in 3D scene capture. Here, “scene capture” refers to the process of generating synthetic camera views of a 3D scene that will serve as input for one or more scene reconstruction techniques. For example, one or more of the techniques described herein be used in combination with scene reconstruction techniques which use synthetic camera views as an input.

In example embodiments, the automatic camera placement techniques may be optimized to improve the quality and/or efficiency of 3D scene capture for subsequent reconstruction and/or visualization.

In example embodiments, a goal of the automatic camera placement method may be to position one or more cameras (e.g., sampling cameras) optimally so that they capture the most relevant information about the scene. In example embodiments, this may result in higher quality reconstruction when the scene is later viewed from arbitrary “rendering camera” positions.

In example embodiments, one or more cameras may be strategically placed based on one or more factors that affect reconstruction quality (e.g., distance from objects, local geometry complexity, and/or texture complexity).

In example embodiments, one or more cameras may be distributed more densely in areas of higher importance.

In example embodiments, one or more cameras may be positioned to properly capture anti-aliasing and other sampling effects

In example embodiments, one or more adaptive techniques (e.g., an adaptive repulsion modulator function and/or an adaptive camera count control) may further refine this scene capture process (e.g., by evaluating the quality of the captured scene and iteratively adjusting camera positions and/or adding and/or removing cameras to improve capture quality.

In example embodiments, this scene capture approach enables high fidelity renders to be compressed and efficiently rendered, such as for product visualization use cases.

In example embodiments, the system may perform operations to enable high-fidelity product visualization on devices with limited computational resources through strategic camera placement and/or scene reconstruction. For example, the system can transform computationally intensive renders into optimized representations by applying automatic camera placement methods to product models. This process may involve capturing a product from multiple optimized viewpoints, with the system determining where sampling cameras should be positioned to maximize visual quality while minimizing computational requirements.

For example, the system may implement a cloud-based workflow in which a product model is processed using the automatic camera placement algorithm, and an optimized representation may be delivered for display on various devices.

These visualization capabilities may provide significant value for industrial applications, e-commerce, retail, and/or product configurators by enabling high-quality product displays across diverse hardware environments.

In example embodiments, the system ensures cross-device compatibility by producing high-definition visual quality on devices that would otherwise be incapable of rendering such fidelity natively. Through one or more automatic camera placement techniques, the system may prioritize important product details (e.g., by allocating higher camera density to areas of greater visual significance, such as distinctive features on a watch or automotive emblems).

In example embodiments, the system achieves resource efficiency by redistributing computational efforts, focusing processing power on rendering important object features while using approximation techniques for less critical areas. This optimization approach enables the system to maintain visual quality even on budget mobile devices, effectively preserving product fidelity across a wide range of hardware while optimizing computational resource utilization.

The system may also apply these techniques to optimize texture compression by evaluating how textures are rendered at runtime and allocating higher resolution to areas that are more frequently viewed.

Current systems for 3D scene capture and visualization face several significant technological problems. Traditional approaches to camera placement for scene reconstruction rely on manual positioning or simplistic automated approaches that fail to account for the varying complexity of different regions within a scene. This results in inefficient use of computational resources and suboptimal visual quality, particularly on resource-constrained devices.

Existing systems also struggle with the challenge of rendering high-fidelity content on low-end devices, as they lack intelligent mechanisms to allocate computational resources based on the importance of different scene elements. When reconstructing 3D scenes, current methods often distribute cameras uniformly or randomly, which leads to wasted computational effort as cameras placed close to each other capture redundant information without adding significant value to the reconstruction.

Additionally, current systems face difficulties in properly capturing complex object details like reflections.

Current texture compression techniques are also problematic as they are based solely on how well the texture is represented, without considering how the texture is actually rendered at runtime. For example, textures are compressed for a game, the metrics of quality may be based on how well the texture is represented; they don't take into account how well the texture is actually rendered at run time.

The system addresses these technological problems through several innovative solutions. First, it implements an automatic camera placement method that strategically positions sampling cameras based on a differentiable neural signed distance field (SDF) or unsigned distance field (UDF). This approach enables the system to automatically orient cameras toward the object using SDF or UDF gradients and optimize camera positions (e.g., through automatic differentiation (autograd) optimization). Autograd is a computational technique that enables the automatic calculation of gradients in neural networks and other differentiable functions. In the context of automatic camera placement, autograd may be utilized when approximating the SDF or UDF with a neural SDF or neural UDF that is differentiable.

In example embodiments, the system described herein introduces a sophisticated mechanism for distributing cameras using repulsion forces modulated by an importance function. This allows for higher camera density in areas of greater visual significance, ensuring that computational resources are allocated efficiently to capture important details. For example, the system can prioritize certain areas (like the right side of a watch) by reducing repulsion forces in those regions, resulting in more cameras being placed there.

To further optimize resource allocation, the system may implement an adaptive approach that evaluates reconstruction quality using separate test cameras and iteratively adjusts the camera placement and/or count based on a quality assessment. This enables the system to spawn additional cameras in areas with insufficient quality and/or remove cameras from areas with excessive quality, dynamically optimizing the capture process.

For texture compression, the system provides a solution that considers how textures are actually rendered at runtime. For example, the system can take a rendered object and automatically place cameras around it and evaluate how many bits are needed to spend on each area of the texture, allowing it to compress the textures more efficiently because the system would not unnecessarily store parts of the textures that would make no difference in the rendering result.

The system may also enable high-fidelity visualization on low-end devices by offloading graphics-intensive computations to a pre-processing stage. This approach allows the system to render content with higher end result fidelity than you might otherwise be able to achieve on a lower end device, potentially achieving high definition render pipeline (HDRP)-like quality on devices that couldn't natively run HDRP.

In example embodiments, the system may be applied to various industrial use cases including robotics, AI training for real-world capture, and product configurators. These applications are particularly valuable as they enable high-fidelity visualization with optimized computational resources.

For resource optimization, the system can be applied not only to low-end devices but also to high-end platforms where computational efficiency remains important. Even with advanced hardware, the system can be utilized for positioning the reconstruction cameras for rendering distant objects or less important scene elements, as computational resources may never be sufficient regardless of hardware capabilities. This approach allows for redistribution of computational effort, focusing rendering resources on more important objects while using approximation techniques for less critical areas.

The system's differentiable nature provides significant advantages for integration with AI tools. With representations like Gaussian splatting, the entire scene becomes completely differentiable, allowing for dynamic adjustment of object parts independently based on visual input or other training criteria. This differentiable quality enables more efficient training compared to traditional polygonal models where information is discretely distributed across vertices and edges.

For transparent surfaces, the system may assume opaque faces when computing the signed distance field. As an extension, the system may incorporate transparency handling by analyzing shader properties to determine visibility through transparent elements. This may enhance the system's ability to properly place cameras when dealing with complex materials like glass or semi-transparent surfaces.

The system can also be applied to neural materials, neural textures, and/or neural shaders. When training these neural rendering components, automated viewing of objects becomes more important as manual specification of all viewing details would be impractical. The automatic camera placement method provides an efficient solution for generating the necessary viewpoints without requiring extensive manual input.

For texture compression optimization, the system evaluates how textures are actually rendered at runtime rather than just how well they are represented in isolation. By automatically placing cameras around rendered objects, the system can evaluate the appropriate bit allocation for each texture area, preventing unnecessary storage of texture details that make no difference in the final rendering result. This approach addresses the issue that traditional texture compression metrics do not account for shader processing or actual runtime appearance.

A method for automatic camera placement is disclosed. A signed distance field (SDF) or unsigned distance field (UDF) is computed for a 3D object in a scene. The SDF or UDF may be approximated with a neural SDF or neural UDF that is differentiable, enabling autograd optimization and/or automatic camera rotation toward the object. One or more initial camera positions are generated randomly (e.g., according to an attractor function that defines where cameras should be placed relative to the object based on distance and importance). One or more repulsion forces between camera pairs are defined to distribute the camera pairs in space (e.g., with a modulator function that can increase camera density in important areas). The one or more initial camera positions are optimized (e.g., by minimizing a loss function that balances repulsion forces and attractor function values).

A method for computing a repulsion modulator function is disclosed. The repulsion modulator function modulates repulsion forces between cameras. The function is computed based on local complexity of object geometry or textures. Parts of the object surface that were closest to each 3D point during SDF or UDF computation are tracked. Locally defined object complexity values are extrapolated into 3D space, decreasing with distance from the object. The extrapolated complexity function is approximated with a differential neural function.

A method for computing an adaptive repulsion modulator is disclosed. This method includes an iterative approach to improve the repulsion modulator function. Sampling cameras are generated. Some of the sampling cameras are randomly designated as test cameras. The camera positions are optimized using the loss function. Scene reconstruction is performed using the input cameras. Reconstruction quality is evaluated using the test cameras. The quality evaluation is extrapolated into 3D space. The repulsion module function is adjusted based on the quality estimation. This process is repeated iteratively.

A method of adaptive camera count control is disclosed. This method extends the adaptive repulsion modulator function approach by dynamically adjusting the number of cameras. The adaptive repulsion modulator technique is performed. Additional cameras are spawned in areas with insufficient reconstruction quality. Cameras are optionally removed from areas with excessive quality. The iterative process to optimize camera placement and/or counts is continued.

An additional method of automatic camera placement is disclosed. A signed distance field (SDF) or unsigned distance field (UDF) is computed for a three-dimensional object in a scene. Initial positions for a plurality of sampling cameras are generated. The initial positions may be generated according to an attractor function that is based on the SDF or the UDF and defines where the plurality of sampling cameras should be placed relative to the three-dimensional object. Repulsion forces between pairs of the plurality of sampling cameras are defined to distribute the plurality of sampling cameras in space. The repulsion forces can be modulated by a repulsion modulator function to increase camera density in areas of higher importance. The initial positions for the plurality of sampling cameras are optimized by minimizing a loss function that balances the repulsion forces between cameras and values of the attractor function at camera positions.

In example embodiments, the modulator function and a count of the plurality of cameras may be adjusted in an iterative manner based on evaluated reconstruction quality.

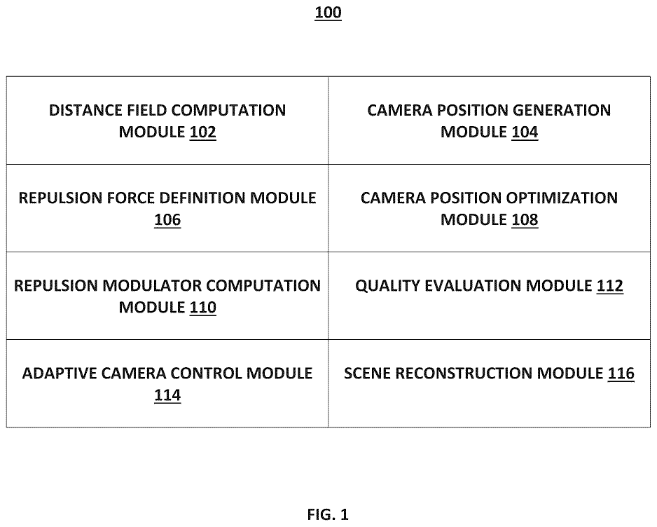

FIG. 1 is a block diagram illustrating example modules of a system for automatic camera placement for 3D scene capture.

In example embodiments, the system includes a distance field computation module 102 configured to compute a signed distance field (SDF) or unsigned distance field (UDF) for a three-dimensional object in a scene and approximate the SDF or UDF with a neural SDF or neural UDF that is differentiable. The neural SDF enables autograd optimization of functions involving SDF or UDF computations and automatic rotation of the generated sampling cameras towards the object by aligning the main camera axis along the neural SDF gradient. For approximating the SDF or UDF, a SIREN network can be used to ensure the resulting neural SDF or neural UDF becomes differentiable.

In example embodiments, the system includes a camera position generation module 104 configured to generate initial positions for a plurality of sampling cameras according to an attractor function that defines where the sampling cameras should be placed relative to the three-dimensional object. The attractor function can be defined as a function of distance from the object along the previously computed neural SDF or UDF, using minimum and maximum distances from the object, or a normal distribution with the mean distance from the object and variance. The module can combine the distance-based attractor function with a volumetric “importance” function for camera positions through multiplication, considering that these functions vary in orthogonal directions.

In example embodiments, the system includes a repulsion force definition module 106 configured to define repulsion forces between pairs of the sampling cameras to distribute the sampling cameras in space. The repulsion forces can be modulated by a repulsion modulator function to increase camera density in areas of higher importance. The repulsion force between two sampling cameras can be defined (e.g., using a Gaussian form that decreases with distance between camera pairs). The module can locally reduce repulsion forces in areas where higher rendering quality is desired by applying the modulator function to interaction forces between cameras positioned in different points in space. Here, the Gaussian function is just one of the possible forms of how the repulsion can be defined. In example embodiments, alternative definitions, like inverse square distance function (which is a more accurate representation of magnetic repulsion) or its differentiable approximations, may be used.

In example embodiments, the system includes a camera position optimization module 108 configured to optimize positions of the sampling cameras by minimizing a loss function that balances the repulsion forces between cameras and the attractor function values at camera positions. The loss function can be defined as a linear combination of the sum of repulsion forces between camera pairs and the sum of attractor function values at camera positions. The module can use different variations of the loss function depending on how the attractor function is defined, including negation variation when there are no restrictions on defined values or reciprocal variation when attractor function values are limited by an interval.

In example embodiments, the system includes a repulsion modulator computation module 110 configured to compute the repulsion modulator function based on local complexity of object geometry or textures. The module tracks which parts of the object surface were closest to each three-dimensional point during SDF or UDF computation and extrapolates locally defined object complexity values into three-dimensional space, with values monotonically decreasing with distance from the object. The extrapolated object complexity function is then approximated with a differential neural function that can be used to compute the repulsion modulator function.

In example embodiments, the system includes a quality evaluation module 112 configured to evaluate reconstruction quality using test sampling cameras that are separate from input sampling cameras used for scene reconstruction. The module compares the rendered reconstruction with reference images at each test camera position and extrapolates the results of the quality evaluation into three-dimensional space to create a volumetric quality estimation function. This function is then used to adjust the repulsion modulator function, either by replacing the previous function or combining with it.

In example embodiments, the system includes an adaptive camera control module 114 configured to adaptively control camera count by spawning additional sampling cameras in areas where reconstruction quality is insufficient and removing sampling cameras from areas where reconstruction quality exceeds a threshold. The module implements an iterative process that continuously refines both camera placement and count based on quality assessment, dynamically optimizing the capture process to achieve desired reconstruction quality throughout the scene.

In example embodiments, the system includes a scene reconstruction module 116 configured to reconstruct the scene using the optimized camera positions to enable high-fidelity visualization on low-end devices. The module offloads graphics-intensive computations to a pre-processing stage, allowing the system to render content with higher fidelity than would otherwise be achievable on resource-constrained devices. This approach enables the system to maintain visual quality across a wide range of hardware while optimizing computational resource utilization.

Within gaming and real-time 3D development platforms, the automatic camera placement technology, including the example modules, can be implemented as one or more cloud-based services that enable developers to create high-fidelity visualizations that run efficiently across a wide range of devices. Developers can utilize this technology through a streamlined workflow where they upload their 3D models to a cloud service, which then processes these models using the automatic camera placement algorithms. The developer workflow involves creating or importing 3D models in the development environment, exporting these models to the cloud service that implements the automatic camera placement algorithms, optionally specifying importance regions on models where higher visual quality is desired, and receiving an optimized representation that can be integrated into their applications.

The system handles the complex process of determining optimal camera positions, capturing the scene from these positions, and generating an efficient representation that preserves visual quality while minimizing computational requirements. By implementing this technology, developers can achieve cross-device compatibility, creating applications that display high-definition visual quality on devices that would otherwise be incapable of rendering such fidelity natively, enabling high-quality visuals on devices that couldn't natively run advanced rendering pipelines, significantly expanding the potential user base for visually rich applications.

The technology allows developers to optimize computational resource utilization by focusing processing power on important object features while using approximation techniques for less critical areas, which is valuable even on high-end devices as it frees up computational resources for other aspects of the application. For e-commerce and product showcase applications, developers can create interactive product visualizations with exceptional detail in key areas without requiring high-end hardware for users, as the system automatically prioritizes visual quality in areas of greater importance, ensuring that product details are preserved even on low-end devices.

The technology enables more efficient texture compression by evaluating how textures are actually rendered at runtime rather than just how well they are represented, resulting in reduced memory usage while maintaining visual quality, as the system allocates higher resolution to areas that are more frequently viewed. The automatic camera placement technology also handles both exterior and interior spaces of objects, enabling developers to create applications where users can examine products from all angles, including internal components when relevant, which is particularly valuable for applications showcasing vehicles, buildings, or products with important interior features.

Developers working on specific industrial applications can expect additional benefits for product configurators, e-commerce, training simulations, and architectural visualization, representing a significant advancement for game and 3D application developers seeking to create visually impressive applications that can run efficiently across a broad spectrum of devices, from high-end workstations to budget mobile phones in developing countries.

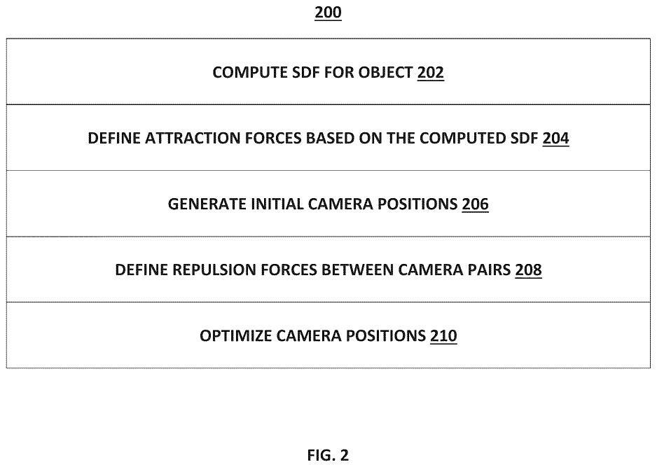

FIG. 2 is a flowchart depicting an example method 200 for automatic camera placement for 3D scene capture. In example embodiments, the operations are performed using one or more of the example modules of FIG. 1.

The described method may be used in combination with one or more scene reconstruction techniques that use synthetic camera views as an input. In example embodiments, the cameras that generate one or more synthetic input views for the scene reconstruction may be referred to as “sampling” cameras, whereas the cameras that render the reconstructed scene at arbitrary positions will be referred to as “rendering” cameras.

In example embodiments, reconstruction of synthetic scenes, which uses rendered views from the sampling cameras as an input, is associated with the automatic placement of those sampling cameras. In example embodiments, the sampling cameras are positioned in such a way that the quality of the reconstructed scene is optimal along expected positions of the rendering cameras.

In example embodiments, one or more of the following factors affect the resulting quality of the reconstruction:
distance of the camera from the objects in the scene;
local complexity of the geometry of the objects;
local complexity of the object textures;
how well the local complexity of the object can be represented using the reconstruction primitives; and/or
ability to properly capture anti-aliasing and other sampling effects.

Depending on a use case scenario and/or based on the listed factors, the following additional information can be provided and used in order to guide the automatic camera placement:
a volumetric function describing the “importance” of the rendering camera positions throughout the space, or in other words, describing where higher density of the sampling cameras would be preferred (e.g., a 3D model of a house, where the “importance” of the rendering cameras positions below the ground level or inside the house is manually set to near zero, while the “importance” of the camera positions at the eye level of the game character related to the house ground level would be maximum); and/or
a function defined along the 2D surface of the objects of the synthetic scene, describing local “importance” of each part of the scene (e.g., a 3D model of a car where the emblem is manually weighted to have higher importance for the reconstruction).

Considering that most reconstruction techniques use a finite number of sampling cameras, it may be assumed that the initial number of the sampling cameras is defined in advance.

At operation 202, an SDF or UDF is computed for the object. In example embodiments, an unsigned distance field may also be sufficient.

In example embodiments, the computed SDF or UDF is approximated with a neural SDF or neural UDF that takes a 3D position as an input. The neural representation may be chosen in such a way that the resulting neural SDF or UDF becomes differential. For example, a SIREN network can be used for this purpose. Using differential SDF or UDF approximation may allow the system to perform the following actions:
autograd optimization of the functions involving SDF or UDF computations; and/or
automatic rotation of the generated sampling cameras towards the object (the main camera axis can be aligned along the neural SDF or neural UDF gradient).

At operation 204, an attractor function is defined based on the computed neural SDF or neural UDF and/or a user input. The attractor function can be defined as a function of distance from the object along the previously computed neural SDF or neural UDF, using parameters such as minimum and maximum distances from the object, or a normal distribution with mean distance and variance. In more advanced scenarios, the resulting attractor function can be computed as a combination of the distance-based attractor function and a volumetric “importance” function (e.g., as provided by the user). The volumetric importance function typically varies along viewing angles while the attractor function varies along distances from the object. Given that these functions vary in orthogonal directions, they can be combined through multiplication to create the final attractor function that guides initial camera placement. The attractor function may define variations in camera positions that allow the object to be captured at target resolution and with sufficient information to resolve sampling issues.

At operation 206, initial positions of the sampling cameras are generated. In example embodiments, the initial positions may be randomly generated according to the value of a specifically designed volumetric “attractor” function, hereafter referred to as a(p), where p is a point in 3D space. In a simple scenario, the attractor function can be defined as a function of the distance from the object along the previously computed neural SDF or neural UDF (e.g., using minimum and maximum distances from the object, or a normal distribution with the mean distance from the object and the variance, etc.). In example embodiments, the attractor function may define the variation of the camera positions that allows the object to be captured at the target resolution, and/or for the object to be captured with sufficient information required to resolve the sampling issues. In example embodiments, it may be sufficient to capture the object along some variation of distances relatively close to the object.

In a more advanced scenario, the resulting attractor function can be computed as a combination of the distance-based attractor function and a volumetric “importance” function for camera positions (e.g., as provided as an additional input to the system). A specific way of combining those functions may depend on the use case, but the basic principle is the following: the volumetric “importance” function for the camera positions normally varies along the viewing angle, while the attractor function normally varies along the distances from the object. Considering that those functions vary in orthogonal directions, one of the possible ways to combine them would be simple multiplication.

At operation 208, a repulsion force is defined for each pair of the sampling cameras. Considering that placing sample cameras close to each other reduces the amount of information about the scene that could be captured with those cameras, it may be more efficient to spread the cameras uniformly in any particular local volume, with varying local density over a larger volume, and in addition the density of the cameras can be anisotropic (e.g., different densities in different directions). It is for this reason that a “repulsion force” may be defined for each pair of the sampling cameras, hereafter referred to as r(c_1,c_2). For example, repulsion force between two sampling cameras c_1 and c_2 located at positions p_1 and p_2 respectively, can be defined using the following Gaussian form (where d is the distance between those points, b and s are additional parameters):

r(c_1,c_2)=b*exp(−d\hat{ }2/(2*s\hat{ }2))

Taking into account the previously mentioned factors affecting the final quality, it may be beneficial to increase the density of the sampling cameras in the areas where higher rendering quality is desired. This can be achieved by locally adjusting the repulsion forces between the cameras using a repulsion modulator function m(p), e.g., in the following way:

r(c_1,c_2)=b*exp(−d\hat{ }2/(2*s\hat{ }2))*m(p_1)*m(p_2)

or, as a variation:

r(c_1,c_2)=b*exp(−d\hat{ }2/(2*s\hat{ }2))*m((p_1+p_2)/2)\hat{ }2

In example embodiments, the system may apply the modulator function to an interaction force between two cameras that are positioned in different points in space. Proper computation may involve integral of the modulator function; however, for performance reasons it may make more sense to use approximations similar to the ones described above (e.g., by combining values of the modulator function sampled at camera positions, or sampling the modulator function in between the camera positions, etc.).

In example embodiments, it is assumed that this function is differentiable.

At operation 210, the sampling cameras are optimized to satisfy one or more conditions. For example, the sampling cameras may be optimized to satisfy one or more of the following conditions:
the density of the sampling cameras should be higher in the areas where the attractor function value is higher; and/or
sampling cameras should uniformly fill the space according to the provided repulsion modulator function.

This can be achieved using optimization of the following linear combination:

loss(c_0,c_1, . . . ,c_n)=sum(r(c_i,c_j))−sum(a(p_i)

or, as a variation assuming that a(p) is strictly positive:

loss(c_0,c_1, . . . ,c_n)=sum(r(c_i,c_j))+sum(1/a(p_i))

A specific variation of the loss function depends on the way the attractor function is defined. When there are no restrictions on the defined values, the negation variation can be used. In the case when the attractor function values are limited by an interval (e.g., 0 . . . 1) the reciprocal variation would be more appropriate. The reason for this is that, in many cases for better final result, the attractor component of the loss function should be very steep, quickly reaching near infinity values.

In the automatic camera placement system, interior space handling may be implemented through a sophisticated approach to distance field computation that offers several technological improvements over conventional methods. When processing three-dimensional objects, the system computes a distance field without inherently differentiating between exterior and interior spaces, treating objects as surface meshes rather than solid volumes. This approach employs an unsigned distance field that treats all polygonal faces as double-sided during distance computation, enabling a more comprehensive capture of object details. The system automatically determines camera placement based on spatial availability. Cameras are positioned within interior volumes when sufficient space exists between surfaces, such as within vehicle cabins or other hollow structures. This spatial analysis is performed algorithmically without requiring manual designation of interior versus exterior spaces, significantly reducing the labor typically required for comprehensive scene capture. In example embodiments, in cases when a scene contains single-sided materials, a decision about whether cameras should be spawned in particular areas or not can be based on the visibility of the polygon back faces.

This approach provides several technological improvements over conventional methods. First, it enables more complete scene reconstruction by capturing both exterior and interior details simultaneously without requiring separate capture processes. Second, it optimizes computational resources by automatically determining where cameras should be placed based on spatial geometry rather than arbitrary or manual placement. Third, it allows for a more accurate representation of objects that have visible interior components, enhancing visual fidelity in the final rendered output.

The practical applications of this interior space handling are extensive and industrially significant. For product visualization, this capability enables comprehensive capture of products with important interior features, such as vehicles where both exterior styling and interior cabin details are critical selling points. In architectural visualization, the system can automatically capture both exterior facades and interior spaces of buildings without requiring separate processing pipelines. For industrial training applications, this approach allows for the creation of detailed virtual environments where users can examine both the exterior and interior of machinery or equipment. Additionally, this capability enhances simulation environments for AI training, particularly for applications like autonomous vehicles or robots that must navigate both exterior and interior spaces.

The system's approach to interior spaces also provides significant advantages for texture optimization. By placing cameras both outside and inside objects, the system can evaluate how textures are rendered from all potential viewing angles, enabling more efficient allocation of texture resolution based on actual visibility during runtime. This comprehensive spatial analysis allows the system to identify which texture areas require higher resolution and which can be compressed more aggressively, resulting in optimized memory usage while maintaining visual quality.

For complex scenarios involving transparent or semi-transparent materials, the system can be extended to incorporate material properties into the camera placement decision process. While the current implementation assumes opaque surfaces by default, advanced implementations could analyze shader properties to determine visibility through transparent elements, further enhancing the system's ability to optimize camera placement for complex materials like glass or semi-transparent surfaces. This capability may be particularly valuable for products like watches with glass faces or vehicles with complex windshield geometries, where capturing reflections and transparency effects accurately is essential for realistic visualization.

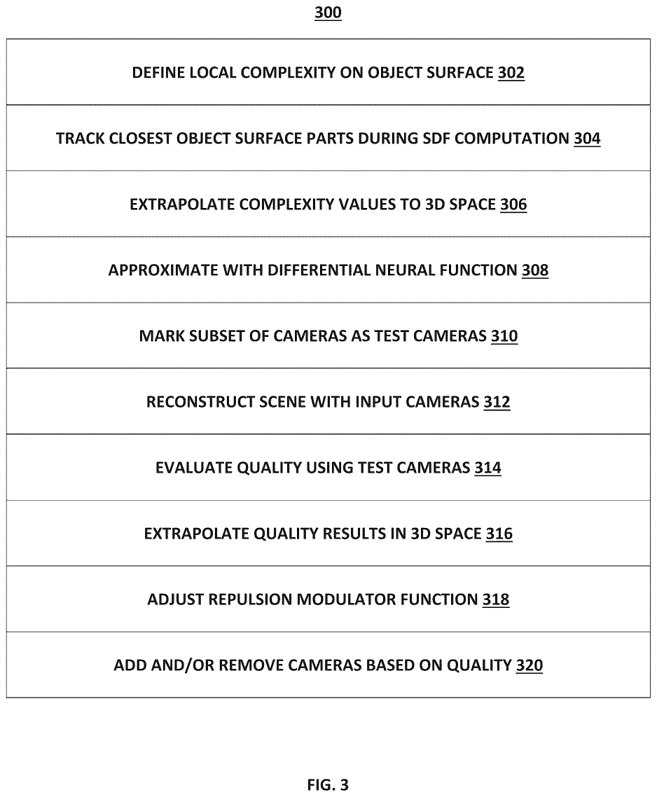

FIG. 3 is a flowchart depicting an example method 300 of computing the repulsion modulator function described with respect to FIG. 2. In example embodiments, the operations are performed using one or more of the example modules of FIG. 1.

At operation 302, a local complexity value is defined on the surface of the three-dimensional object. In example embodiments, the local complexity may be based on the geometry of the object, the object textures, and/or how well the local complexity can be represented using reconstruction primitives.

At operation 304, the parts of the object surface that were closest to each three-dimensional point are tracked during the computation of the original signed SDF or UDF.

At operation 306, the locally defined object complexity value is extrapolated toward each three-dimensional point, with the value monotonically decreasing with distance from the object.

At operation 308, the extrapolated object complexity function is approximated with a differential neural function that can be used to compute the repulsion modulator function.

At operation 310, a portion of the sampling cameras are randomly marked as test cameras, with the remaining cameras considered to be input cameras.

At operation 312, the scene is reconstructed using the input sampling cameras.

At operation 314, the quality of the reconstruction is evaluated using the test sampling cameras by comparing the rendered reconstruction with reference images.

At operation 316, the results of the quality evaluation are extrapolated into three-dimensional space to create a volumetric quality estimation function.

At operation 318, the repulsion modulator function is automatically adjusted according to the extrapolated volumetric quality estimation function, either by replacing the previous function or combining with it.

At operation 320, additional cameras are spawned in areas where the quality appears to be insufficient, and optionally some cameras are removed from areas where the reconstruction quality is too high.

In example embodiments, the repulsion modulator function depends on the use case, and in a simple scenario can be computed based on the local complexity of the object geometry or object texture. The only obstacle here is that usually the local complexity of the object can be only defined on the surface of the object, while the repulsion modulator function should be defined for each 3D point. Assuming that the generated sample cameras will be oriented towards the object based on the previously computed neural SDF or neural UDF, it is also possible to track which parts of the object surface were the closest to each 3D point while computing the original SDF or UDF, and extrapolate the locally defined object complexity value towards that 3D point (which should be monotonically decreasing with the distance from the object). The resulting extrapolated object complexity function, now defined for each 3D point where SDF or UDF was computed, can be also approximated with a differential neural function and used to compute the repulsion modulator function.

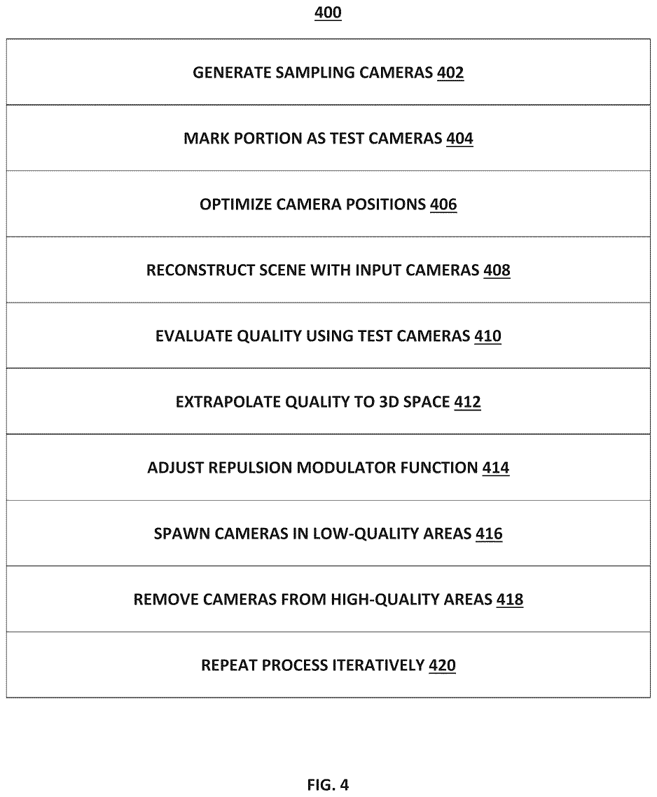

FIG. 4 is a flowchart depicting an example method 400 of computing an adaptive repulsion modulator function. In example embodiments, the operations are performed using one or more of the example modules of FIG. 1.

At operation 402, a set of sampling cameras is generated according to an attractor function, which builds upon the local complexity values defined in operation 302 of FIG. 3, as both processes utilize information about the three-dimensional object to determine initial camera placement.

At operation 404, a portion of the sampling cameras is randomly marked as test cameras, while the remaining cameras are designated as input cameras. This step enables quality evaluation.

At operation 406, optimization of a loss function is performed to arrange the sampling cameras in space, similar to how the extrapolated complexity values from operations 304-308 in FIG. 3 are used to influence camera distribution.

At operation 408, reconstruction of the scene is performed using only the input sampling cameras, which is a prerequisite for the quality evaluation that follows.

At operation 410, the quality of the reconstruction is evaluated using the test sampling cameras. This extends the concept from operation 314 in FIG. 3, but applies it specifically to the test cameras designated in operation 404.

At operation 412, the results of the quality evaluation are extrapolated into three-dimensional space, similar to operation 316 in FIG. 3, but now based on actual reconstruction quality rather than just object complexity.

At operation 414, the repulsion modulator function is automatically adjusted according to the extrapolated quality function. This corresponds to operation 318 in FIG. 3, but incorporates the quality-based information from operations 410-412.

At operation 416, additional cameras are randomly spawned in areas where the reconstruction quality is insufficient. This extends operation 320 in FIG. 3 by specifically targeting quality-deficient areas identified in operations 410-412.

At operation 418, some cameras are optionally removed from areas where the reconstruction quality exceeds a threshold. This step complements operation 416 and extends the camera count control concept from operation 320 in FIG. 3.

At operation 420, this process is repeated iteratively from operation 404, creating a feedback loop that continuously refines the camera placement based on quality assessment. This enhances the iterative nature implied in FIG. 3's operations 310-320.

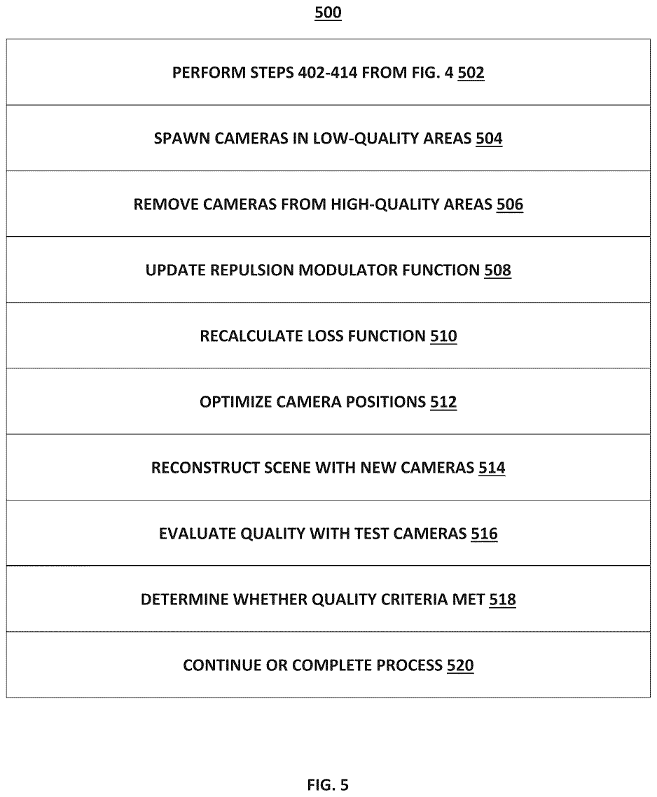

FIG. 5 is a flowchart depicting an example method 500 of computing adaptive camera count control. In example embodiments, the operations are performed using one or more of the example modules of FIG. 1.

At operation 502, the steps from operations 402-414 of FIG. 4 are performed, which include generating sampling cameras, designating test and input cameras, optimizing camera positions, performing scene reconstruction, evaluating quality, and adjusting the repulsion modulator function.

At operation 504, additional cameras are randomly spawned in areas where the reconstruction quality is determined to be insufficient, which extends operation 416 in FIG. 4.

At operation 506, a portion of the cameras are removed from areas where the reconstruction quality is too high, which is similar to operation 418 in FIG. 4.

At operation 508, the repulsion modulator function is updated based on the new camera distribution, incorporating both the quality assessment from operation 502 and the camera count adjustments from operations 504 and 506.

At operation 510, the loss function is recalculated to account for the new camera distribution and updated repulsion modulator function.

At operation 512, the positions of the remaining and newly added cameras are optimized according to the updated loss function and updated repulsion modulator function.

At operation 514, the scene reconstruction is performed again using the new set of input cameras with their optimized positions.

At operation 516, the quality of the updated reconstruction is evaluated using the new set of test cameras.

At operation 518, a determination is made whether the reconstruction quality meets predetermined criteria across the entire scene.

At operation 520, if the quality criteria are not met, the process returns to operation 504 to continue the adaptive camera count control; otherwise, the process is completed with an optimized set of cameras that balances count and placement for efficient scene reconstruction.

In some cases, the desired final number of generated cameras highly depends on the expected reconstruction quality, which in its turn depends on how well the local complexity of the object can be represented using the reconstruction primitives; therefore it may not be known in advance.

The method 700 is designed specifically for such scenarios, and includes the following additional steps for adjusting the repulsion modulator function: randomly spawning more cameras in the areas where the quality appears to be insufficient; and/or optionally removing some portion of the cameras from the areas where the reconstruction quality is too high.

As a result, the combined method not only computes adaptive repulsion modulator function, but also iteratively controls the camera count based on the local estimation of the reconstruction quality.

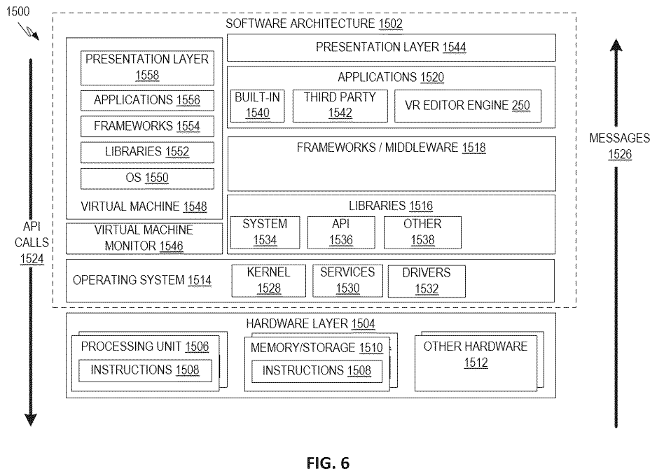

FIG. 6 is a block diagram 1500 illustrating a representative software architecture 1502, which may be used in conjunction with various hardware architectures described herein to provide the MR tools described herein. FIG. 6 is merely a non-limiting example of a software architecture and it will be appreciated that many other architectures may be implemented to facilitate the functionality described herein. The software architecture 1502 may be executing on hardware such as machine 1600 of FIG. 6 that includes, among other things, processors 1610, memory 1630, and I/O components 1650. A representative hardware layer 1504 is illustrated and can represent, for example, the machine 1600 of FIG. 6. The representative hardware layer 1504 comprises one or more processing units 1506 having associated executable instructions 1508. Executable instructions 1508 represent the executable instructions of the software architecture 1502, including implementation of the methods, modules and so forth described herein. Hardware layer 1504 also includes memory or storage modules 1510, which also have executable instructions 1508. Hardware layer 1504 may also comprise other hardware as indicated by 1512 which represents any other hardware of the hardware layer 1504, such as the other hardware illustrated as part of machine 1600.

In the example architecture of FIG. 6, the software 1502 may be conceptualized as a stack of layers where each layer provides particular functionality. For example, the software 1502 may include layers such as an operating system 1514, libraries 1516, frameworks/middleware 1518, applications 1520 and presentation layer 1544. Operationally, the applications 1520 or other components within the layers may invoke application programming interface (API) calls 1524 through the software stack and receive a response, returned values, and so forth illustrated as messages 1526 in response to the API calls 1524. The layers illustrated are representative in nature and not all software architectures have all layers. For example, some mobile or special purpose operating systems may not provide a frameworks/middleware layer 1518, while others may provide such a layer. Other software architectures may include additional or different layers.

The operating system 1514 may manage hardware resources and provide common services. The operating system 1514 may include, for example, a kernel 1528, services 1530, and drivers 1532. The kernel 1528 may act as an abstraction layer between the hardware and the other software layers. For example, the kernel 1528 may be responsible for memory management, processor management (e.g., scheduling), component management, networking, security settings, and so on. The services 1530 may provide other common services for the other software layers. The drivers 1532 may be responsible for controlling or interfacing with the underlying hardware. For instance, the drivers 1532 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 1516 may provide a common infrastructure that may be utilized by the applications 1520 or other components or layers. The libraries 1516 typically provide functionality that allows other software modules to perform tasks in an easier fashion than to interface directly with the underlying operating system 1514 functionality (e.g., kernel 1528, services 1530 or drivers 1532). The libraries 1516 may include system 1534 libraries (e.g., C standard library) that may provide functions such as memory allocation functions, string manipulation functions, mathematic functions, and the like. In addition, the libraries 1516 may include API libraries 1536 such as media libraries (e.g., libraries to support presentation and manipulation of various media format such as MPREG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 1516 may also include a wide variety of other libraries 1538 to provide many other APIs to the applications 1520 and other software components/modules.

The frameworks 1518 (also sometimes referred to as middleware) may provide a higher-level common infrastructure that may be utilized by the applications 1520 or other software components/modules. For example, the frameworks 1518 may provide various graphic user interface (GUI) functions, high-level resource management, high-level location services, and so forth. The frameworks 1518 may provide a broad spectrum of other APIs that may be utilized by the applications 1520 or other software components/modules, some of which may be specific to a particular operating system or platform.

The applications 1520 includes built-in applications 1540 or third party applications 1542. Examples of representative built-in applications 1540 may include, but are not limited to, a contacts application, a browser application, a book reader application, a location application, a media application, a messaging application, a VR engine 1401, or a game application. Third party applications 1542 may include any of the built in applications as well as a broad assortment of other applications. In a specific example, the third party application 1542 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third party application 1542 may invoke the API calls 1524 provided by the mobile operating system such as operating system 1514 to facilitate functionality described herein.

The applications 1520 may utilize built in operating system functions (e.g., kernel 1528, services 1530 or drivers 1532), libraries (e.g., system 1534, APIs 1536, and other libraries 1538), frameworks/middleware 1518 to create user interfaces to interact with users of the system. Alternatively, or additionally, in some systems interactions with a user may occur through a presentation layer, such as presentation layer 1544. In these systems, the application/module “logic” can be separated from the aspects of the application/module that interact with a user.

Some software architectures utilize virtual machines. In the example of FIG. 6, this is illustrated by virtual machine 1548. A virtual machine creates a software environment where applications/modules can execute as if they were executing on a hardware machine. A virtual machine is hosted by a host operating system (operating system 1514 in FIG. 6) and typically, although not always, has a virtual machine monitor 1546, which manages the operation of the virtual machine as well as the interface with the host operating system (i.e., operating system 1514). A software architecture executes within the virtual machine such as an operating system 1550, libraries 1552, frameworks/middleware 1554, applications 1556 or presentation layer 1558. These layers of software architecture executing within the virtual machine 1548 can be the same as corresponding layers previously described or may be different.

In the example embodiment, the VR engine 1401 operates as an application in the applications 1520 layer. However, in some embodiments, the VR engine 1401 may operate in other software layers, or in multiple software layers (e.g., framework 1518 and application 1520), or in any architecture that enables the systems and methods as described herein. The VR engine 1401 may be similar to the VR engine 112.

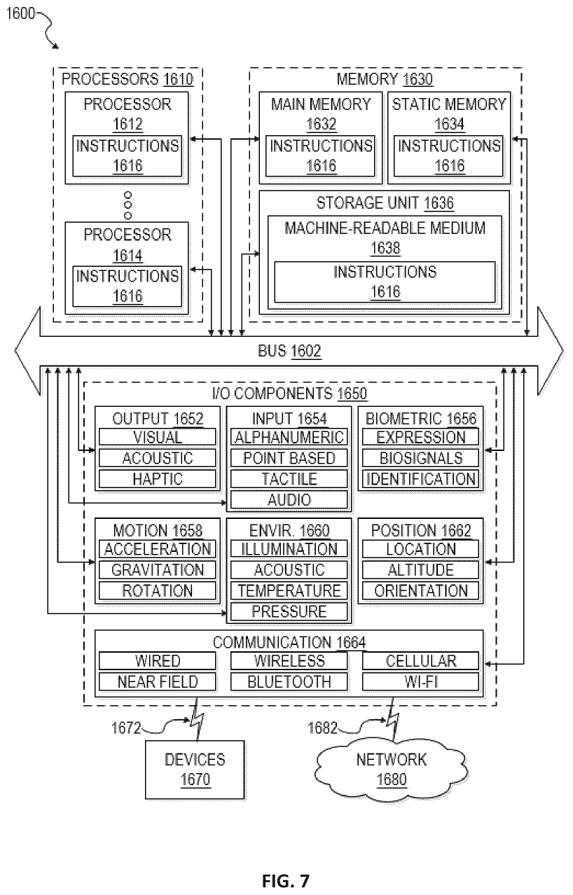

FIG. 7 is a block diagram illustrating components of a machine 1600, according to some example embodiments, able to read instructions from a machine-readable medium 1638 (e.g., a machine-readable storage medium) and perform any one or more of the VR methodologies discussed herein. Specifically, FIG. 7 shows a diagrammatic representation of the machine 1600 in the example form of a computer system, within which instructions 1616 (e.g., software, a program, an application, an applet, an app, or other executable code) for causing the machine 1600 to perform any one or more of the methodologies discussed herein may be executed. For example, the instructions may cause the machine to execute any of the operations described herein. The instructions transform the general, non-programmed machine into a particular machine programmed to carry out the described and illustrated functions in the manner described. In alternative embodiments, the machine 1600 operates as a standalone device or may be coupled (e.g., networked) to other machines. In a networked deployment, the machine 1600 may operate in the capacity of a server machine or a client machine in a server-client network environment, or as a peer machine in a peer-to-peer (or distributed) network environment. The machine 1600 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1616, sequentially or otherwise, that specify actions to be taken by machine 1600. Further, while only a single machine 1600 is illustrated, the term “machine” shall also be taken to include a collection of machines 1600 that individually or jointly execute the instructions 1616 to perform any one or more of the methodologies discussed herein.

The machine 1600 may include processors 1610, memory 1630, and I/O components 1650, which may be configured to communicate with each other such as via a bus 1602. In an example embodiment, the processors 1610 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, processor 1612 and processor 1614 that may execute instructions 1616. The term “processor” is intended to include multi-core processor that may comprise two or more independent processors (sometimes referred to as “cores”) that may execute instructions contemporaneously. Although FIG. 7 shows multiple processors, the machine 1600 may include a single processor with a single core, a single processor with multiple cores (e.g., a multi-core process), multiple processors with a single core, multiple processors with multiples cores, or any combination thereof.

The memory/storage 1630 may include a memory 1632, such as a main memory, or other memory storage, and a storage unit 1636, both accessible to the processors 1610 such as via the bus 1602. The storage unit 1636 and memory 1632 store the instructions 1616 embodying any one or more of the methodologies or functions described herein. The instructions 1616 may also reside, completely or partially, within the memory 1632, within the storage unit 1636, within at least one of the processors 1610 (e.g., within the processor's cache memory), or any suitable combination thereof, during execution thereof by the machine 1600. Accordingly, the memory 1632, the storage unit 1636, and the memory of processors 1610 are examples of machine-readable media.

As used herein, “machine-readable medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) or any suitable combination thereof. The term “machine-readable medium” should be taken to include a single medium or multiple media (e.g., a centralized or distributed database, or associated caches and servers) able to store instructions 1616. The term “machine-readable medium” shall also be taken to include any medium, or combination of multiple media, that is capable of storing instructions (e.g., instructions 1616) for execution by a machine (e.g., machine 1600), such that the instructions, when executed by one or more processors of the machine 1600 (e.g., processors 1610), cause the machine 1600 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes transitory signals per se.

The I/O components 1650 may include a wide variety of components to receive input, provide output, produce output, transmit information, exchange information, capture measurements, and so on. The specific I/O components 1650 that are included in a particular machine will depend on the type of machine. For example, portable machines such as mobile phones will likely include a touch input device or other such input mechanisms, while a headless server machine will likely not include such a touch input device. It will be appreciated that the I/O components 1650 may include many other components that are not shown in FIG. 7. The I/O components 1650 are grouped according to functionality merely for simplifying the following discussion and the grouping is in no way limiting. In various example embodiments, the I/O components 1650 may include output components 1652 and input components 1654. The output components 1652 may include visual components (e.g., displays such as a plasma display panel (PDP), a light emitting diode (LED) display, a liquid crystal display (LCD), a projector, a cathode ray tube (CRT), or wearable devices such as head-mounted display (HMD) devices), acoustic components (e.g., speakers), haptic components (e.g., a vibratory motor, resistance mechanisms), other signal generators, and so forth. The input components 1654 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location or force of touches or touch gestures, or other tactile input components), motion-sensing input components (e.g., hand controllers), audio input components (e.g., a microphone), and the like.

In further example embodiments, the I/O components 1650 may include biometric components 1656, motion components 1658, environmental components 1660, or position components 1662 among a wide array of other components. For example, the biometric components 1656 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1658 may include acceleration sensor components (e.g., accelerometer), gravitation sensor components, rotation sensor components (e.g., gyroscope), position-sensing components, and so forth. The environmental components 1660 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1662 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1650 may include communication components 1664 operable to couple the machine 1600 to a network 1680 or devices 1670 via coupling 1682 and coupling 1672 respectively. For example, the communication components 1664 may include a network interface component or other suitable device to interface with the network 1680. In further examples, communication components 1664 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1670 may be another machine or any of a wide variety of peripheral devices (e.g., a peripheral device coupled via a Universal Serial Bus (USB)).

In various example embodiments, one or more portions of the network 1680 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 1680 or a portion of the network 1680 may include a wireless or cellular network and the coupling 1682 may be a Code Division Multiple Access (CDMA) connection, a Global System for Mobile communications (GSM) connection, or other type of cellular or wireless coupling. In this example, the coupling 1682 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 1616 may be transmitted or received over the network 1680 using a transmission medium via a network interface device (e.g., a network interface component included in the communication components 1664) and utilizing any one of a number of well-known transfer protocols (e.g., hypertext transfer protocol (HTTP)). Similarly, the instructions 1616 may be transmitted or received using a transmission medium via the coupling 1672 (e.g., a peer-to-peer coupling) to devices 1670. The term “transmission medium” shall be taken to include any intangible medium that is capable of storing, encoding, or carrying instructions 1616 for execution by the machine 1600, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

1. A non-transitory computer-readable storage medium storing a set of instructions that, when executed by one or more computer processors, causes the one or more computer processors to perform operations, the operations comprising:
computing a signed distance field (SDF) or unsigned distance field (UDF) for a three-dimensional object in a scene;
generating initial positions for a plurality of sampling cameras according to an attractor function that is based on the SDF or UDF and defines where the plurality of sampling cameras should be placed relative to the three-dimensional object;
defining repulsion forces between pairs of the plurality of sampling cameras to distribute the plurality of sampling cameras in space, wherein the repulsion forces can be modulated by a repulsion modulator function to increase camera density in areas of higher importance; and
optimizing positions of the plurality of sampling cameras by minimizing a loss function that balances the repulsion forces between cameras and values of the attractor function at camera positions.

2. The non-transitory computer-readable storage medium of claim 1, wherein the computing of the SDF or UDF includes approximating the SDF or UDF with a neural SDF.

3. The non-transitory computer-readable storage medium of claim 2, wherein the neural SDF enables autograd optimization of functions involving SDF computations and automatic rotation of the plurality of sampling cameras toward the three-dimensional object.

4. The non-transitory computer-readable storage medium of claim 1, wherein the generating of the initial positions for the plurality of sampling cameras comprises randomly generating the initial positions according to the attractor function.

5. The non-transitory computer-readable storage medium of claim 4, wherein the attractor function is defined as a function of distance from the three-dimensional object based on the signed distance field.

6. The non-transitory computer-readable storage medium of claim 1, wherein the defining of the repulsion forces between the pairs of the plurality of sampling cameras comprises applying a Gaussian repulsion function that decreases with distance between camera pairs.

7. The non-transitory computer-readable storage medium of claim 1, wherein the repulsion modulator function locally reduces repulsion forces in areas where higher camera density is desired to improve reconstruction quality.

8. The non-transitory computer-readable storage medium of claim 1, wherein the optimizing of the positions of the plurality of sampling cameras comprises iteratively adjusting camera positions to minimize the loss function.

9. The non-transitory computer-readable storage medium of claim 1, wherein the loss function is defined as a linear combination of a sum of repulsion forces between camera pairs and a sum of attractor function values at camera positions.

10. The non-transitory computer-readable storage medium of claim 1, wherein the operations further comprise evaluating reconstruction quality using test sampling cameras that are separate from input sampling cameras used for scene reconstruction, and adaptively adjusting the repulsion modulator function based on reconstruction quality.

11. The non-transitory computer-readable storage medium of claim 10, wherein the operations further comprise extrapolating the reconstruction quality into three-dimensional space to create a volumetric quality estimation function that is used to adjust the repulsion modulator function.

12. The non-transitory computer-readable storage medium of claim 10, wherein the operations further comprise adaptively controlling camera count by spawning additional sampling cameras in areas where reconstruction quality is insufficient and optionally removing sampling cameras from areas where reconstruction quality exceeds a threshold.

13. The non-transitory computer-readable storage medium of claim 1, wherein the repulsion modulator function is computed based on local complexity of at least one of: object geometry, object textures, or expected representation using reconstruction primitives.

14. The non-transitory computer-readable storage medium of claim 1, wherein the operations further comprise automatically orienting the sampling cameras toward the three-dimensional object using gradients of the SDF.

15. The non-transitory computer-readable storage medium of claim 1, wherein the operations further comprise using the optimized positions of the plurality of cameras for training neural materials, neural textures, or neural shaders without requiring manual specification of camera positions.

16. The non-transitory computer-readable storage medium of claim 1, wherein the operations further comprise using the optimized positions of the plurality of cameras for synthetic scene reconstruction to render high-fidelity content on low-end devices by offloading graphics-intensive computations to a pre-processing stage, thereby enabling visualization with higher quality than would otherwise be achievable on a target device.

17. The non-transitory computer-readable storage medium of claim 1, wherein the operations further comprise extrapolating local complexity values defined on a surface of the three-dimensional object into three-dimensional space by tracking which parts of the object surface were closest to each three-dimensional point during SDF computation, and using the extrapolated local complexity values to compute the repulsion modulator function.

18. The non-transitory computer-readable storage medium of claim 1, wherein the operations further comprise optimizing texture compression by evaluating how textures are rendered at runtime and allocating higher resolution to areas that are more frequently viewed.

19. A method comprising:
computing a signed distance field (SDF) unsigned distance field (UDF) for a three-dimensional object in a scene;
generating initial positions for a plurality of sampling cameras according to an attractor function that is based on the SDF or UDF and defines where the plurality of sampling cameras should be placed relative to the three-dimensional object;
defining repulsion forces between pairs of the plurality of sampling cameras to distribute the plurality of sampling cameras in space, wherein the repulsion forces can be modulated by a repulsion modulator function to increase camera density in areas of higher importance; and
optimizing positions of the plurality of sampling cameras by minimizing a loss function that balances the repulsion forces between cameras and values of the attractor function at camera positions.

20. A system comprising:
one or more computer processors;
one or more computer memories;
a set of instructions stored in the one or more computer memories, the set of instructions configuring the one or more computer processors to perform operations, the operations comprising:
computing a signed distance field (SDF) or unsigned distance field (UDF) for a three-dimensional object in a scene;
generating initial positions for a plurality of sampling cameras according to an attractor function that is based on the SDF or UDF and defines where the plurality of sampling cameras should be placed relative to the three-dimensional object;
defining repulsion forces between pairs of the plurality of sampling cameras to distribute the plurality of sampling cameras in space, wherein the repulsion forces can be modulated by a repulsion modulator function to increase camera density in areas of higher importance; and
optimizing positions of the plurality of sampling cameras by minimizing a loss function that balances the repulsion forces between cameras and values of the attractor function at camera positions.
